(19) United States
(12) Patent Application Publication
(10) Pub. No.: US 2017/0367417 A1
(43) Pub. Date: Dec. 28, 2017

(54) Fastener And Article Equipped With The Fastener

(71) Applicant: 3M INNOVATIVE PROPERTIES COMPANY, St. Paul, MN (US)

(72) Inventors: Tadahiro Takashina, Sagamihara-shi (JP); Junghan Kim, Seoul (KR); Marina Kawazoe, Sagamihara (JP)

(21) Appl. No.: 15/540,287

(22) PCT Filed: Jan. 11, 2016
(86) PCT No.: PCT/US2016/012793

§ 371 Date: Jun. 28, 2017

(30) Foreign Application Priority Data
Jan. 16, 2015 (JP) 2015-007162

(51) Int. Cl. A41D 13/11; A44B 11/04; A44B 99/00; A62B 18/08; A41F 1/00; F16B 5/12; F16B 2/22

(52) U.S. Cl. CPC A41D 13/1161; A62B 18/08; A44B 11/04; A41F 1/008; A44B 99/005; F16B 2/22; F16B 5/12

(57) ABSTRACT

Problem: To provide a fastener that facilitates attachment of a string and makes it unlikely for the attached string to come off. Solution: The fastener according to one aspect of the present invention is a fastener for fastening a string-like body to an article, and includes a slit opening part for inserting the string-like body, and a string-like body holding part which communicates with the slit opening part and holds the string-like body inserted from the slit opening part. The string-like body holding part extends in the left and right directions from the slit opening part, a surface of the string-like body holding part facing the slit opening part is smooth, and a projecting part is provided at a position adjacent to the slit opening part on the surface of the string-like body holding part.

### TECHNICAL FIELD

One aspect of the present invention relates to a fastener and an article equipped with the fastener.

### BACKGROUND ART

Fasteners for fastening string-like bodies to articles are conventionally known.

Patent document 1 below describes a fastening string length adjuster for fastening a fastening string to a mask. Patent document 1 describes that “the fastening string length adjuster for a mask comprises a plate-shaped main body, and the main body is provided with: an introducing hole for introducing an elastically deformable fastening string having a prescribed width and a prescribed thickness; a first guide slit, having a right end of the first guide slit communicating with the introducing hole, and extending in a lateral direction for guiding the fastening string in the introducing hole to a first fastening slit; a second guide slit, having a left end thereof communicating with the introducing hole, and extending in a lateral direction for guiding the fastening string in the introducing hole to a second fastening slit; wherein the first fastening slit, having an intermediate part in a longitudinal direction communicating with a left end of the first guide slit, extends in a longitudinal direction for fastening the fastening string from the first guide slit; and the second fastening slit, having an intermediate part in a longitudinal direction communicating with a right end of the second guide slit, extends in a longitudinal direction for fastening the fastening string from the second guide slit.”

### SUMMARY OF THE INVENTION

With a fastener for fastening a string-like body to an article, it is required that the fastened string-like body be securely attached to the article and that the string-like body be unlikely to come off from the article. However, with a fastener that can securely fasten a string-like body, there is generally a situation in which the string-like body may be unlikely to come off from the article, but on the other hand, attachment of the string-like body is complex and troublesome. Meanwhile, with a fastener that can facilitate attachment of a string-like body, there is a situation in which the string-like body may be fastened easily but the fastened string-like body easily comes off from the article.

An object of one aspect of the present invention is to provide a fastener that facilitates attachment of a string-like body and makes it unlikely for the attached string-like body to come off, and to provide an article equipped with the fastener.

### Means for Solving the Problem

The fastener according to one embodiment of the present invention is a fastener for fastening a string-like body to an article, and includes a slit opening part for inserting the string-like body, and a string-like body holding part which communicates with the slit opening part and holds the string-like body inserted from the slit opening part. The string-like body holding part extends in the left and right directions from the slit opening part, a surface of the string-like body holding part facing the slit opening part is smooth, and a projecting part is provided at a position adjacent to the slit opening part on the surface of the string-like body holding part.

### Effect of the Invention

According to one embodiment of the present invention, attachment of the string-like body is facilitated and the attached string-like body is unlikely to come off.

### BRIEF DESCRIPTION OF THE DRAWINGS

FIG. 1 is a perspective view illustrating the state of use of a mask as one example of the article according to an embodiment.

FIGS. 2(a) and (b) are drawings illustrating the fastener according to an embodiment.

FIG. 3(a) is a drawing illustrating an example of the slit opening part and the string-like body holding part, and (b) is an enlarged view of the location where the slit opening part and the string-like body holding part communicate.

FIG. 4 is a drawing illustrating an example of the string-like body holding part.

FIG. 5 is a drawing illustrating an example of the string-like body holding part.

FIGS. 6(a), (b), (c), and (d) are drawings illustrating the state in which the string-like body is passed from the slit opening part and through the string-like body holding part and is attached to the fastener.

### DESCRIPTION OF THE EMBODIMENTS

Embodiments of the present invention are described in detail below while referring to the attached drawings. Identical reference numerals are assigned to identical or equivalent elements in the descriptions of the drawings, and redundant descriptions are omitted.

The structures of the fastener and article according to an embodiment are described. First, the term “string-like body” in the present specification signifies a long and slender article, including a string used in the general sense, for holding, binding, or wrapping an object. In the present specification, the cross-sectional shape when the string-like body is cut on a plane intersecting at a right angle with the direction of extension of the string-like body is rectangular, and a flat string-like body having a fixed width is given as an example, but the cross-sectional shape of the string-like body is not limited thereto. For example, the cross-sectional shape of the string-like body may be circular, elliptical, or the like.

The term “fastening” in the present specification indicates attaching the string-like body to a member to be fastened. “Fastening” is not only fixing the string-like body to the member to be fastened, but also includes movably attaching the string-like body to the member to be fastened. For example, “fastening” also includes attaching the string-like body to the member to be fastened such that after the string-like body is attached to the member to be fastened, the length of the string-like body extending from the member to be fastened is adjustable (can be regulated).

“Article” in the present specification indicates various kinds of members to be fastened to which the string-like body is fastened, and may be, for example, a mask, goggles, or other protective gear having a string-like body. However, “article” may be an article other than the aforementioned protective gear, and the kinds of “articles” are diverse.

“Fastener” indicates a part or portion for fastening the string-like body to the article (member to be fastened), and may be used, for example, for attachment of the string-like body to the article. A specific example of a use is for attachment of the string-like body to a main body of a mask, goggles, or other protective gear. However, the use of this “fastener” is not limited to the above protective gear. Also, “fastener” includes not only items for fixing the string-like body to the article, but also items for movably attaching the string-like body to the article. For example, “fastener” also includes items for attaching the string-like body to the article so that the length of the string-like body extending from the article is adjustable (can be regulated).

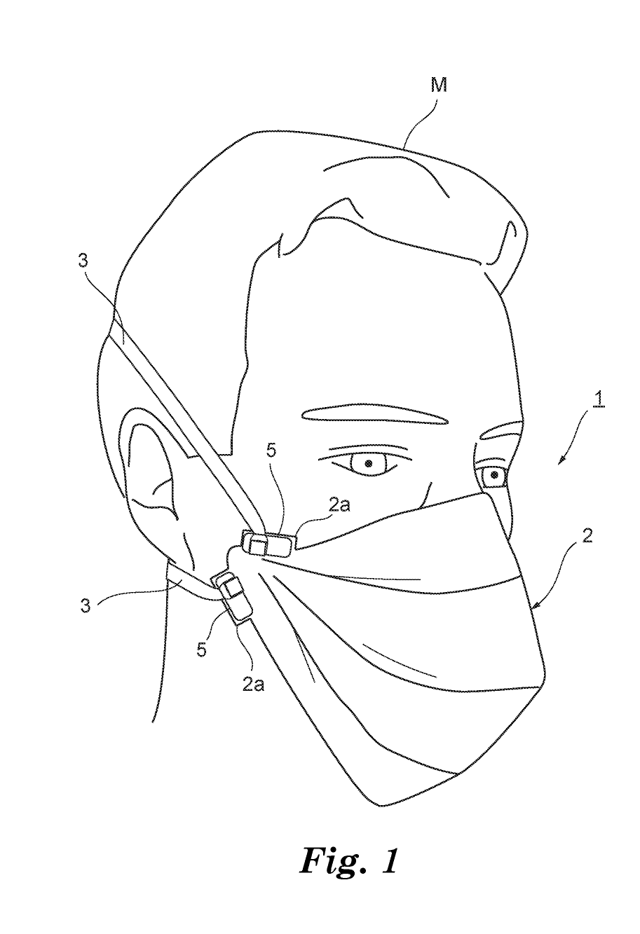

As one example of the article, FIG. 1 illustrates a mask 1 in which fitting and adjustment for wearing by a wearer M is facilitated. The mask 1 is simply adjusted to suit various users to bring about security for increased safety and a comfortable fit. The mask 1 often includes an entangled web of electrostatic microfiber, specifically melt blown microfiber (BMF). The mask 1 may also be a filter face mask similar to that described in U.S. Pat. No. 7,028,689 filed by the same applicants as in the present application.

The mask 1 has a cup-shaped mask main body 2. “Mask main body” indicates, for example, the portion covering the mouth and nose of the wearer M, and signifies a breathable structure separating and partitioning an external gas space and an internal gas space. Also, “cup-form” signifies a container-form shape capable of covering the nose and mouth of the wearer M. The mask 1 can cover a part or the entirety of the face of the wearer M for protective or sanitary purpose. Also, the mask 1 may have numerous other shapes, such as of a mask that is folded flat in two, disclosed in U.S. Design Pat. No. 443,927 by Chen et al.

The mask main body 2 can have a filter cartridge for a mask as illustrated in U.S. Pat. No. 5,062,421. In addition, the mask main body 2 can be applied to be used with a positive pressure air intake. Examples of positive pressure masks are disclosed in U.S. Pat. No. 5,924,420 by Grannis et al., and U.S. Pat. No. 4,790,306 by Braun et al. The mask main body 2 is configured not only to cover only the nose and mouth of the wearer M (such mask is called a “half mask”), but also may be configured to cover also the eyes for protection of vision of the wearer M in addition to the respiratory system of the wearer M (such mask is called a “full face mask”) (see, for example, U.S. Pat. No. 5,924,420 by Reischel et al.). The mask main body 2 may be placed at a distance from the face of the wearer M, or may be closely overlaid or placed at a very close position on the face of the wearer M. The mask main body 2 has a thermal fit indication seal on the periphery, so that the wearer M can easily confirm whether or not an appropriate fit is established (see U.S. Pat. No. 5,617,849 by Springet et al.).

Also, the mask main body 2 is adapted to fit the nose and mouth of the wearer M in a relationship at a distance from the face of wearer M so as to create an internal air space or gap between the face of the wearer M and the inner surface of the mask main body 2. In the mask main body 2 of the type illustrated in FIG. 1, substantially the entirety of the exposed surface of the mask main body 2 is fluid permeable with respect to inhalation. When the wearer M inhales, air is taken in through the mask main body 2, and airborne particles are captured in gaps between the fibrous materials used as a filter inside the mask main body 2. The mask main body 2 can also have a curved hemispheric shape. However, the mask main body 2 can take substantially any and all suitable shapes in accordance with the final use. The mask main body 2 may include numerous layers such as an inner molded layer and an outer filter layer. The mask main body 2 may be a cup-form mask, but may also have a triple-folded structure that can be folded up flat when not being used and can be opened into a cup form when being used (see U.S. Pat. No. 6,123,077 by Bostock et al., U.S. Design Pat. No. 431,647 by Henderson et al., and U.S. Design Pat. No. 424,688 by Bryant et al.).

Examples of fibrous materials that can be used as a filter inside the mask main body 2 are disclosed in U.S. Pat. No. 5,706,804 by Baumann et al., U.S. Pat. No. 4,419,993 by Peterson, U.S. Reissued Pat. No. 28,102 by Mayhew, U.S. Pat. No. 5,472,481 and U.S. Pat. No. 5,411,576 by Jones et al., and U.S. Pat. No. 5,908,598 by Rousseau et al. These fibers may include polymers such as polypropylene and/or poly-4-methyl-1-pentene (see U.S. Pat. No. 4,874,399 by Jones et al. and U.S. Pat. No. 6,057,256 by Dyrud et al.), and may include fluorine atoms and/or other additives to increase filtering performance (see U.S. patent application Publication Ser. No. 09/109,497 (published as International Publication No. 00/01737) in the name of “Fluorinated Electret,” and U.S. Pat. No. 5,025,052 and U.S. Pat. No. 5,099,026 by Crater et al.), and may have low concentrations of extractable hydrocarbons for increasing performance (see U.S. Pat. No. 6,213,122 by Rousseau et al.). A fibrous web also may be fabricated to provide enhanced oil mist resistance as described in U.S. Pat. No. 4,874,399 by Reed et al., as well as U.S. Pat. No. 6,238,466 and U.S. Pat. No. 6,068,799 (both by Rousseau et al.).

Two string-like bodies 3 and a fastener 5 for fastening the string-like bodies 3 to the mask main body 2 are provided on the mask main body 2 in order to hold the mask 1 closely to the face of the wearer M. The quantity and placement of fasteners 5 for fastening the string-like bodies 3 to the mask main body 2 can be in many modes, and are not particularly limited. For example, a fastener 5 is interposed between the mask main body 2 and a string-like body 3, but may also be interposed between a string-like body 3 and another string-like body 3, and the position where the fastener 5 is provided is not particularly limited. Also, as one example of a mode of placement of fasteners 5, four fasteners 5 are attached outside (on the side opposite the wearer M) of rectangle edges 2a positioned at the corners of the mask main body 2. Two fasteners 5 of the four fasteners 5 are positioned on the right side of the wearer M, and the remaining two fasteners 5 are positioned on the left side of the wearer M. The two fasteners 5 positioned on the right side and the two fasteners 5 positioned on the left side are provided together in pairs, above and below.

The mode of placement of the string-like body 3 is not particularly limited. For example, one of two string-like bodies 3 extends from the fastener 5 positioned on the upper side and right side of the wearer M to the fastener 5 positioned on the upper side and left side of the wearer M. The other of the two string-like bodies 3 extends from the fastener 5 positioned on the lower side and right side of the wearer M to the fastener 5 positioned on the lower side and left side of the wearer M. Each string-like body 3 curves and extends between the two fasteners 5, and the length of the string-like body 3 positioned between the two fasteners 5 is adjustable by adjusting the position of the string-like body 3 relative to the fastener 5.

The string-like body 3 may be a flexible member having an elastic property, and may also be a member not having an elastic property. The string-like body 3 can be fabricated using various materials. Typical materials of string-like bodies 3 configured as members having an elastic property include isoprene, polyisoprene, natural rubber, and the like. Other typical materials include Spandex™ and Neprene™. [The string-like body] may also be an elastic rubber material knitted in cloth such as polyester to provide a comfortable feel to a wearer M having an allergic reaction to specific materials. Meanwhile, examples of typical materials of string-like bodies 3 configured as members not having an elastic property include polypropylene and other polyolefins, polyester, nylon, cotton, and the like. The string-like body 3 holds the mask main body 2 in a desired position on the wearer M to help realize an appropriate fit.

The material of the fastener 5 is not particularly limited, and is, for example, thermoplastic resin. This thermoplastic resin includes polypropylene, polyethylene, nylon, and the like. The fastener 5 is manufactured, for example, by injection molding, but may be manufactured by press processing, laser processing, or bend processing, and the method of manufacturing the fastener 5 is not particularly limited.

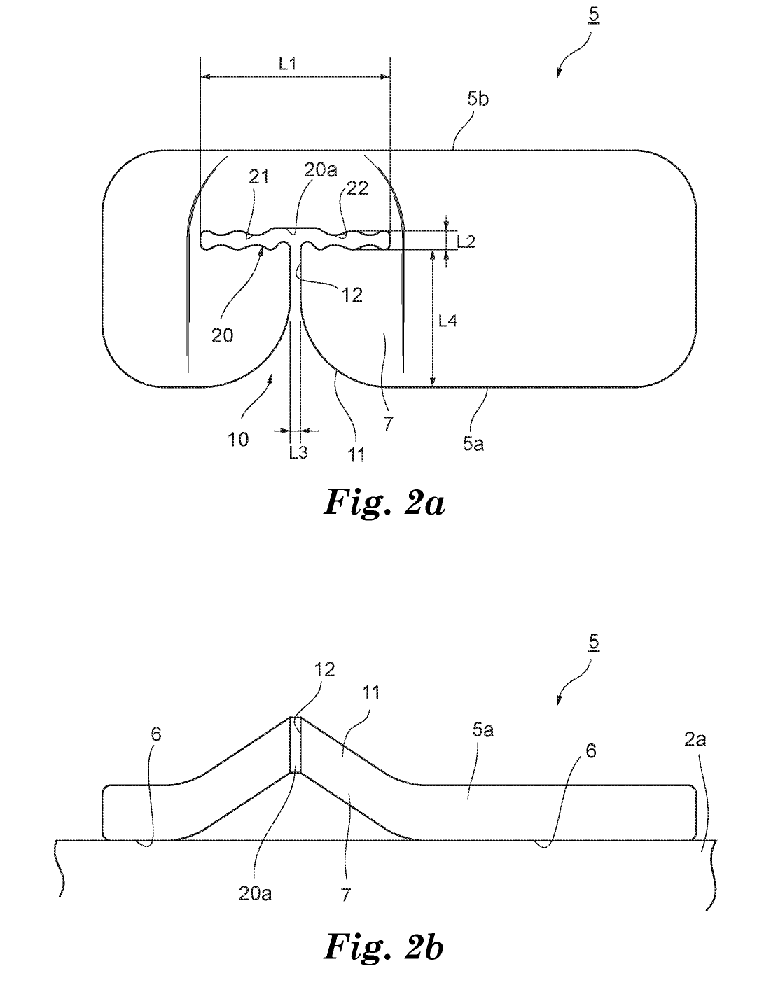

The external shape of the fastener 5 also is not limited. One example of the external shape of the fastener 5 is a parallelepiped shape having rounded corners as illustrated in FIG. 2. For example, a fixing part 6 to be fixed to an edge 2a of the mask main body 2 is provided on one surface of the fastener 5. The mode of the fixing part 6 is not in any way limited. For example, the fixing part 6 may be formed as a contact surface for contacting with the edge 2a of the mask main body 2, and may be fixed to the edge 2a of the mask main body 2 by ultrasonic welding processing or by an adhesive agent, or the like.

As one example of the external shape of the fastener 5, the fastener 5 has a shape in which a slit opening part 10 and a string-like body holding part 20 are spaced apart from the mask 1 when [the fastener] is fixed to the mask 1 by the fixing part 6. For example, the fastener 5 can be provided with a raised part 7 rising from the fixing part 6 as illustrated in FIG. 2, and the shape in which the slit opening part 10 and the string-like body holding part 20 are spaced apart from the mask 1 is realized by this raised part 7. “Slit opening part” in the present specification indicates a slit-shaped opening, and “slit” is a concept including a slit-shaped perforation. “String-like body holding part” in the present specification is a hole formed by perforation, and indicates a place for holding the string-like body by inserting the string-like body into the inside thereof. Various shapes are conceivable as shapes of the raised part 7. For example, the raised part 7 may exhibit an inverse U shape extending from a side surface 5a of the fastener 5 to a side surface 5b on the opposite side.

The slit opening part 10, for example, has a string-like body insertion part 11 formed so that the width becomes narrower going from the side surface 5a of the fastener 5 toward the side face 5b facing the side surface 5a, and a string-like body guiding part 12 that extends from the side surface 5b of the string-like body insertion part 11 toward the string-like body holding part 20. The shape and size of the string-like body insertion part 11 are not particularly limited. An example of the shape of the string-like body insertion part 11 is arc-form, parabolic shape or the like. The mode of the string-like body guiding part 12 also is not particularly limited. For example, the string-like body holding part 20 may be formed on an end of the other side surface 5b of the string-like body guiding part 12. In this case, when the string-like body 3 is attached to the fastener 5, for example, the string-like body 3 moves to the string-like body insertion part 11, the string-like body guiding part 12, and the string-like body holding part 20 in this order. That is, the string-like body guiding part 12 can be interposed between the string-like body insertion part 11 and the string-like body holding part 20 as illustrated in the example of FIG. 2. Also, the string-like body guiding part 12 may be formed at the highest place of the raised part 7, and the place where the string-like body guiding part 12 and the string-like body holding part 20 are provided may be spaced apart from the mask main body 2 when fixing the fastener 5 to the mask main body 2.

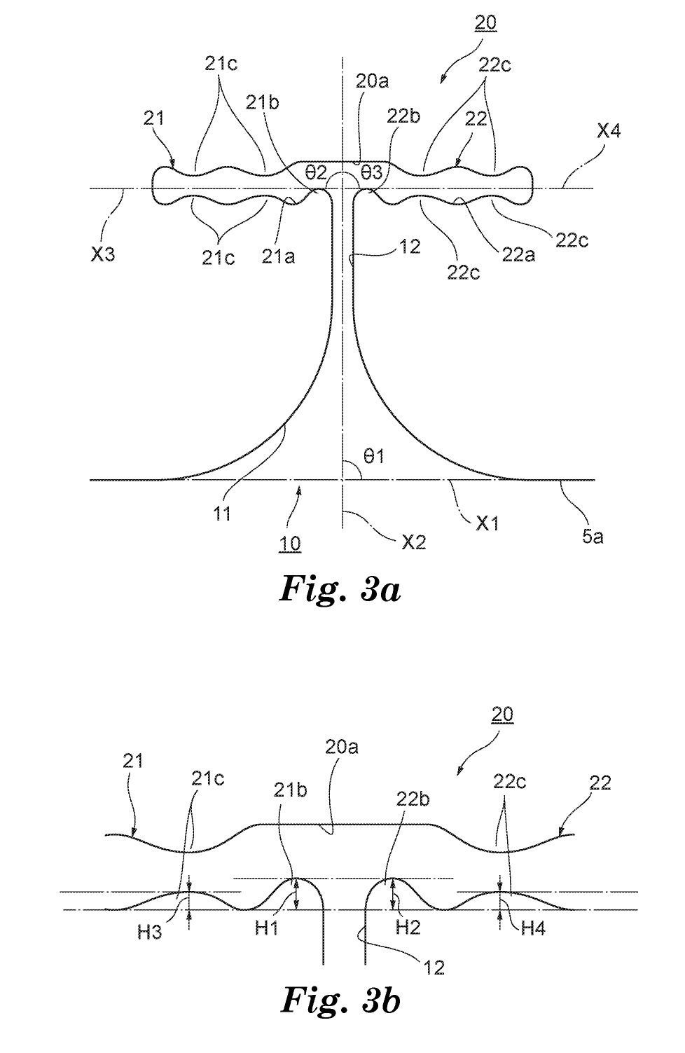

Various shapes of the string-like body holding part 20 are described below. FIGS. 3 to 5 illustrate various string-like body holding parts 20. In FIGS. 3 to 5, the string-like body holding part 20 exhibits a shape extending in the left and right directions from the slit opening part 10 (more specifically, the string-like body guiding part 12). FIGS. 3 to 5 show a reference line X1 along the side surface 5a of the fastener 5, a reference line X2 along the direction of extension of the string-like body guiding part 12, a reference line X3 along the string-like body holding part 20 extending toward the left side from the string-like body guiding part 12, and a reference line X4 along the string-like body holding part 20 extending toward the right side from the string-like body guiding part 12. The reference line X1 and the reference line X2 intersect at angle θ1, the reference line X3 and the reference line X2 intersect at angle θ2, and the reference line X4 and the reference line X2 intersect at angle θ3. Also, in FIGS. 3 to 5, the reference numerals for the string-like body holding part 20 and the elements configuring the string-like body holding part 20 are kept the same to facilitate understanding of the description.

The string-like body holding part 20 illustrated in the example in FIG. 3 has a first holding part 21 extending from the string-like body guiding part 12 toward the left side, and a second holding part 22 extending from the string-like body guiding part 12 toward the right side. For example, in FIG. 3(a), the angle θ1 formed by the reference line X1 and the reference line X2 is 90°, but the angle θ1 may be other than 90°. Also, the angle θ2 formed by the reference line X2 and the reference line X3 and the angle θ3 formed by the reference line X2 and the reference line X4 are both 90° in FIG. 3(a). However, angle θ2 and angle θ3 can also be angles other than 90°.

The shapes and sizes of the first holding part 21 and second holding part 22 are not particularly limited. For example, in FIG. 3, the first holding part 21 and the second holding part 22 are in a continuous linear form, and the first holding part 21, the second holding part 22, and the string-like body guiding part 12 are formed in a T shape. A string-like body 3 inserted from the slit opening part 10 is held by first holding part 21 and the second holding part 22. Also, the surface 20a of the string-like body holding part 20 facing the slit opening part 10 is formed as a smooth surface, for example, as a flat surface.

In the present specification, “facing” indicates two objects facing each other, and “surface of the string-like body holding part facing the slit opening part” indicates a surface facing the side of the slit opening part of the surfaces forming the string-like body holding part, and a surface of the string-like body holding part that is abutted by the string-like body passing through from the slit opening part. Also, in the present specification, “smooth surface” indicates a flat surface or curved surface, and indicates a smooth surface not having any sharp portions, rough portions, or irregular-surface portions to an extent that passage of the string-like body 3 is impeded.

Also, the width L3 of the string-like body guiding part 12 may be narrower than the width L2 of the string-like body holding part 20 (the first holding part 21 and the second holding part 22), as illustrated in FIG. 2. Here, the width L2 of the string-like body holding part 20 indicates the maximum width of the string-like body holding part 20, and indicates, specifically, the distance between a valley of the string-like body holding part 20 and a valley facing that valley as shown in FIG. 2. Here, “facing” indicates a state in which one surface forming the string-like body holding part faces another surface forming the string-like body holding part.

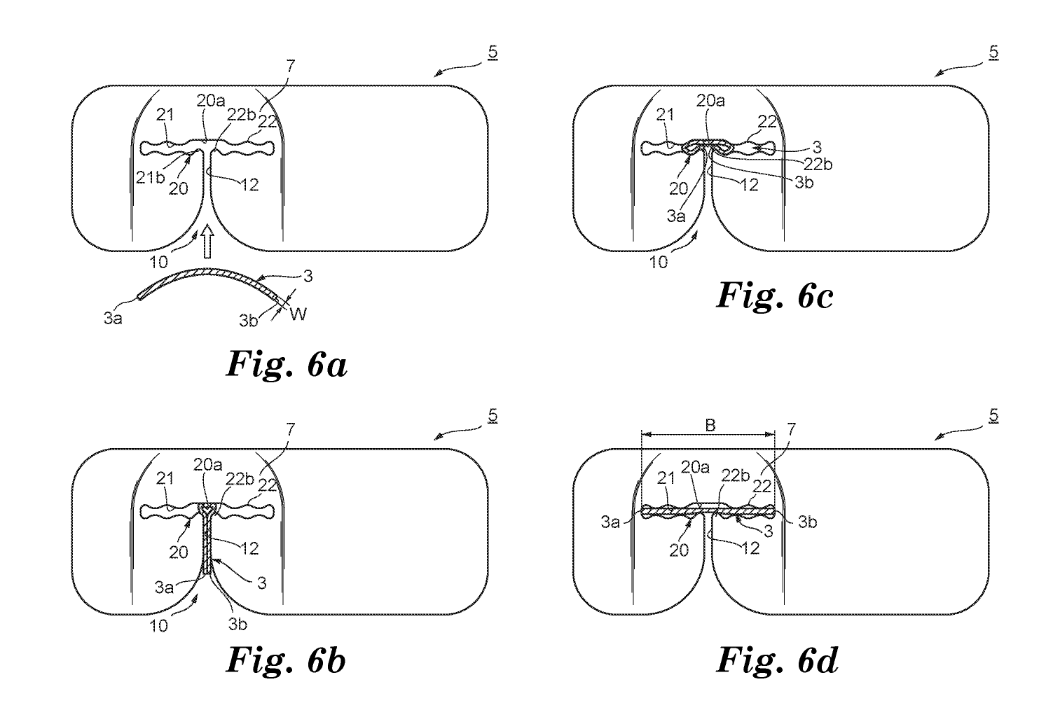

Also, a length L1 of the string-like body holding part 20 (the first holding part 21 and the second holding part 22) and a distance L4 from the side surface 5a of the fastener 5 to the string-like body holding part 20 can be designed in accordance with a width B (see FIG. 6(d)) of the string-like body 3. For example, the length L1 or the distance L4 may be to an extent somewhat longer than the width B of the string-like body 3.

As illustrated in FIG. 3(a) and FIG. 3(b), in a portion adjacent to the string-like body guiding part 12 on a surface 21a of the first holding part 21, that is, in a portion extending continuously from the string-like body guiding part 12, there is formed a projecting part 21b projecting toward the inside of the first holding part 21 relative to the surface 21a (in the direction from the string-like body guiding part 12 to the surface 20a). The shape of the projecting part 21b is not particularly limited. For example, the projecting shape 21b may be a parabolic or arc-form.

Also, a protruding part 21c may be formed at the surface 21a of the first holding part 21. The first holding part 21 includes two surfaces 21a facing each other, and for example, a protruding part 21c may be formed on each of these two surfaces 21a. The protruding part 21c is formed at a position not interfering with the projecting part 21b. The shape and quantity of the protruding part 21c are not particularly limited. For example, a plurality of protruding parts 21c may be formed at each fixed interval on the surface 21a, whereby peaks and valleys may be formed alternately on the surface 21a. In this case, a portion where a protruding part 21c is formed on the surface 21a is a peak, and a portion where a protruding part 21c is not formed is a valley. The quantity of protruding parts 21c is, for example, four. Two protruding parts 21c of the four protruding parts 21c are formed in positions on the surface 21a (left side of the projecting part 21b) further from the string-like body guiding part 12 than the projecting part 21b. The remaining two protruding parts 21c are formed, for example, on the surface opposite the above two protruding parts 21c.

A height H3 of the protruding part 21c is, for example, lower than a height H1 of the projecting part 21b. Here, the height H3 of the protruding part 21c indicates the distance between the valley on the surface 21a and the peak of the protruding part 21c, and the height H1 of the projecting part 21b indicates the distance between the valley on the surface 21a and the peak of the projecting part 21b. It may be that the height H3 is not lower than the height H1, for example, the height H3 may be identical to the height H1. When the height H3 of the protruding part 21c is lower than the height H1 of the projecting part 21b, the string-like body 3 catches on the projecting part 21b positioned in a portion adjacent to the string-like body guiding part 12 and comes to be held by the string-like body holding part 20, and the string-like body 3 is therefore unlikely to come off from the string-like body guiding part 12.

The second holding part 22 has, for example, the same configuration as the first holding part 21. That is, a projecting part 22b is formed at a portion adjacent to the string-like body guiding part 12 on the surface 22a of the second holding part 22. The length of the second holding part 22 extending from the string-like body guiding part 12 may be identical to or different from the length of the first holding part 21 extending from the string-like body guiding part 12. A protruding part 22c which is similar to the protruding part 21c is formed on the surface 22a of the second holding part 22. Here, a height H4 of the protruding part 22c indicates the distance between the valley on the surface 22a and the peak of the protruding part 22c, and a height H2 of the projecting part 22b indicates the distance between the valley on the surface 22a and the peak of the projecting part 22b. As for the relationship between the height H4 and the height H2, it may be that the height H4 is not lower than the height H2, for example, the height H4 may be identical to the height H2. When the height H4 of the protruding part 22c is lower than the height H2 of the projecting part 22b, the string-like body 3 catches on the projecting part 22b positioned at a portion adjacent to the string-like body guiding part 12 and comes to be held by the string-like body holding part 20, and the string-like body 3 is therefore unlikely to come off from the string-like body guiding part 12

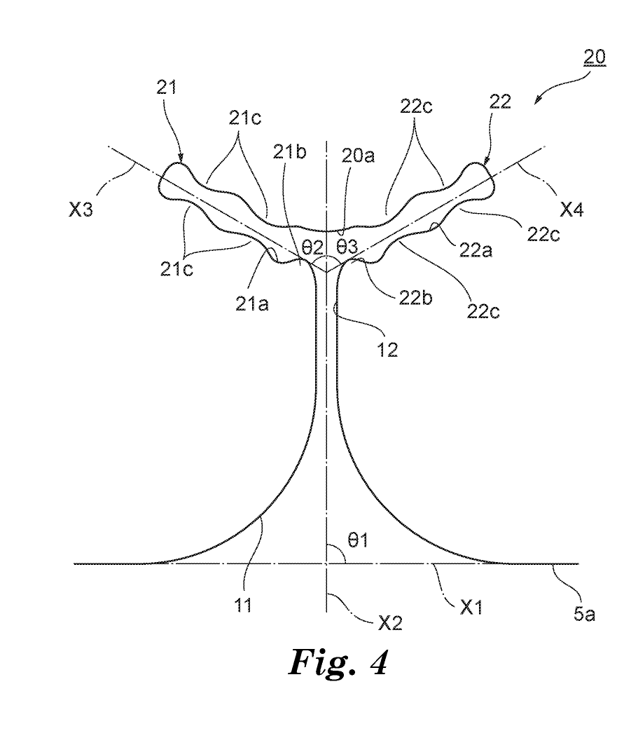

The example in FIG. 4 illustrates a string-like body holding part 20 in which the angle θ2 formed by the reference line X2 and the reference line X3 and the angle θ3 formed by the reference line X2 and the reference line X4 both are acute angles. In this string-like body holding part 20, the first holding part 21, the second holding part 22, and the string-like body guiding part 12 are formed in a Y shape. Also, the surface 20a of the string-like body holding part 20 facing the string-like body guiding part 12 is formed as a curved surface curving gently in a U shape. FIG. 4 illustrates an example in which the angle θ2 and the angle θ3 both are acute angles, but it may be that only either one of angle θ2 and angle θ3 is an acute angle. Also, the surface 20a may be formed as a flat surface or as a curved surface having a different shape from the above.

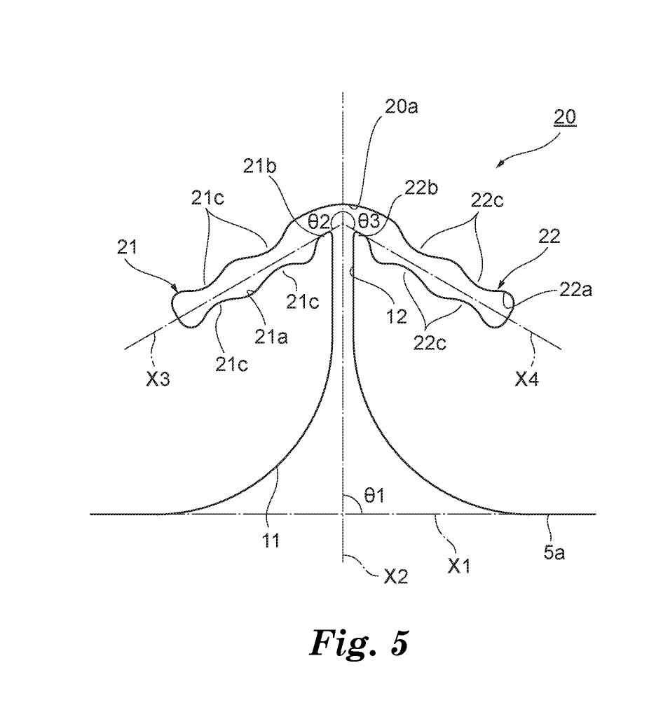

The example in FIG. 5 illustrates a string-like body holding part 20 in which the angle θ2 formed by the reference line X2 and the reference line X3 and the angle θ3 formed by the reference line X2 and the reference line X4 both are obtuse angles. In this example, the string-like body guiding part 12 and the string-like body holding part 20 are formed in an umbrella shape. The surface 20a of the string-like body holding part 20 facing the string-like body guiding part 12 is formed as a curved surface curving gently in an inverse U shape. In FIG. 5, the angle θ2 and the angle θ3 both are obtuse angles, but it may be that only either one of the angle θ2 and the angle θ3 is an obtuse angle. Also, the surface 20a may be formed as a flat surface or as a curved surface having a different shape from the above.

An example of the method for attaching the string-like body 3 to the fastener 5 is next described. In the example below, the string-like body 3 is held by the string-like body holding part 20 illustrated in FIG. 3. Various kinds of string-like bodies 3 can be held by the string-like body holding part 20. In the example below, a string-like body 3 in which the width B (see FIG. 6) is the same extent as the length L1 of the string-like body holding part 20 and a thickness W is somewhat thicker than the width L3 of the string-like body guiding part 12 is held by the string-like body holding part 20.

First, as illustrated in FIG. 6(a), the string-like body 3 is folded in two so that the shape of the string-like body 3 viewed from the lengthwise direction of the string-like body 3 becomes an inverse U shape, and while in a state of being folded in two, the string-like body 3 is inserted into the slit opening part 10.

Next, as illustrated in FIG. 6(b), the folded string-like body 3 is guided from the string-like body insertion part 11 to the string-like body guiding part 12, the string-like body 3 is caused to abut the surface 20a of the string-like body holding part 20, and the string-like body 3 is pushed in further toward the string-like body holding part 20. At this time, the string-like body 3 contacts the smooth surface 20a of the string-like body holding part 20, and the portion of the string-like body 3 contacting the surface 20a spreads in the left and right directions from the surface 20a.

Next, as illustrated in FIG. 6(c), when the string-like body 3 is pushed in further toward the string-like body holding part 20, one end 3a in the width direction of the string-like body 3 enters in toward the first holding part 21 from the string-like body guiding part 12, and the other end 3b in the width direction of the string-like body 3 enters in toward the second holding part 22 from the string-like body guiding part 12. At this time, the string-like body 3 becomes an entirely balled-up shape, and one portion thereof becomes in a state following the smooth surface 20a of the string-like body holding part 20.

Also, as illustrated in FIG. 6(d), when the string-like body 3 is moved in the penetration direction of the string-like body holding part 20 (the direction of the paper surface in FIG. 6), one end 3a and the other end 3b of the string-like body 3 move in directions moving away from the string-like body guiding part 12, the string-like body 3 becomes in a state extending in a straight line in the width direction, and the string-like body 3 is held by the string-like body holding part 20 (the first holding part 21 and the second holding part 22). In this state, the string-like body 3 is abutted by the projecting part 21b and the protruding part 21c of the first holding part 21, and is abutted by the projecting part 22b and the protruding part 22c of the second holding part 22. Thus one end 3a of the string-like body 3 is held by the first holding part 21, and the other end 3b of the string-like body 3 is held by the second holding part 22, whereby the string-like body 3 is held by the string-like body holding part 20 and is attached to the fastener 5. In this state, the string-like body 3 can move in the penetration direction of the string-like body holding part 20, and therefore the length of the string-like body 3 extending from the fastener 5 can be adjusted. For example, the length of the string-like body 3 positioned between two fasteners 5 can be adjusted.

In the fastener 5 as above, the string-like body 3 can be easily attached by merely inserting the string-like body 3 into the slit opening part 10, moving one end 3a of the string-like body 3 to the first holding part 21, and moving the other end 3b of the string-like body 3 to the second holding part 22. Also, because the string-like body 3 moves smoothly in the left and right directions from the string-like body guiding part 12 due to the smooth surface 20a, attachment of the string-like body 3 can be facilitated. Therefore, it becomes possible to fasten the string-like body 3 to the fastener 5 simply even when using a machine. Accordingly, in an actual manufacturing process, the number of masks 1 produced per unit time can be increased, and it is advantageous in the aspect of productivity. Furthermore, because the string-like body 3 cannot easily enter into the string-like body guiding part 12 due to the projecting parts 21b and 22b, the string-like body 3 becomes unlikely to come off from the string-like body guiding part 12.

The present invention is described in detail below on the basis of embodiments, but the present invention is not in any way limited thereto.

As illustrated in FIGS. 1, 2, and 6, the fastener 5 according to an embodiment is fixed on the outside of the edge 2a of the mask main body 2. In the fastener 5 according to the embodiment, the length L1 of the string-like body holding part is 6.40 mm. Also, the width L2 of the string-like body holding part (the distance between valleys on the string-like body holding part) is 0.80 mm, the distance between peaks of the string-like body holding part is 0.44 mm, and the width L3 of the string-like body guiding part is 0.40 mm.

The string-like body 3 according to the embodiment is a flexible member having an elastic property, and the thickness W becomes thinner when the string-like body 3 is stretched in the direction of extension (lengthwise direction) of the string-like body 3. The width B of the string-like body 3 according to the embodiment is 4.60 mm. Also, the thickness W1 of the string-like body 3 in the unstretched state is 0.90 mm, and the thickness W2 of the string-like body 3 in the stretched state is 0.40 mm.

As above, the length L1 of the string-like body holding part is longer than the width B of the string-like body 3. Also, the thickness W1 of the string-like body 3 in the unstretched state is thicker than the width L2 of the string-like body holding part, and the distance between peaks of the string-like body holding part is greater than or equal to the thickness W2 of the string-like body 3 when stretched thin, and is less than or equal to two times the thickness W2 of the string-like body when stretched thinner. It was confirmed that when such fastener 5 is used, attachment of the string-like body 3 is facilitated, and the attached string-like body 3 is unlikely to come off.

As described above, the fastener according to one aspect of the present invention is a fastener for fastening a string-like body to an article, and includes a slit opening part for inserting the string-like body, and a string-like body holding part which communicates with the slit opening part and holds the string-like body inserted from the slit opening part. The string-like body holding part extends in the left and right directions from the slit opening part, a surface of the string-like body holding part facing the slit opening part is smooth, and a projecting part is provided at a position adjacent to the slit opening part on the surface of the string-like body holding part.

The article according to one embodiment of the present invention is equipped with the above fastener.

According to such an embodiment, there is provided a slit opening part for inserting the string-like body, and the string-like body holding part for holding the string-like body extends in the left and right directions from the slit opening part. Accordingly, when the string-like body is inserted from the slit opening part and the string-like body contacts with the smooth surface of the string-like body holding part, the string-like body moves smoothly in the left direction and the right direction from the smooth surface. Thus, because the string-like body can be moved smoothly and can be held in the string-like body holding part that extends in the left and right directions from the slit opening part, the string-like body can be easily attached to the fastener. Also, a projecting part is provided at a position adjacent to the slit opening part on the surface of the string-like body holding part. Because the string-like body catches onto the string-like body holding part by this projecting part and comes to be held, the string-like body held by the string-like body holding part is unlikely to enter into the slit opening part. Accordingly, the string-like body can be made unlikely to come off from the string-like body holding part.

In the fastener according to another aspect, a protruding part may be further provided on the surface of the string-like body holding part.

In this case, holding of the string-like body in the string-like body holding part is accomplished by abutting of the protruding part with the string-like body. Accordingly, the protruding part provided on the surface of the string-like body holding part abuts with the string-like body, movement of the string-like body in the left and right directions (the directions in which the string-like body holding part extends) and in the front and back directions (the lengthwise direction of the string-like body) is restricted, and the string-like body does not easily slide toward the front, back, left, and right (movement of the string-like body is restricted) by this protruding part. Therefore, adjustment (regulation) of the length of the string-like body can be performed accurately.

In the fastener according to another embodiment, the height of the projecting part may be higher than the height of the protruding part.

In this case, the height of the projecting part provided at a position adjacent to the slit opening part is higher than the height of the protruding part, and the projecting part abuts with the string-like body. Accordingly, when [the fastener] is combined with the string-like body of a certain embodiment, the string-like body does not easily slide toward the front, back, left, and right directions and catches on and is held by the string-like body holding part, and therefore the string-like body can be more effectively made unlikely to be removed from the slit opening part.

In the fastener according to another embodiment, the fastener may have a fixing part to be fixed to the article, and may have a shape in which the slit opening part and the string-like body holding part are spaced apart from the article when the fastener is fixed to the article by the fixing part.

In this case, the slit opening part is provided at a position spaced apart from the article, and the string-like body passes through the slit opening part at a position spaced apart from the article. Accordingly, the string-like body does not easily interfere with the article, and the string-like body therefore can be passed easily through the slit opening part.

In the fastener according to another embodiment, the slit opening part may have a string-like body insertion part and a string-like body guiding part, and the width of the string-like body guiding part may be narrower than the width of the string-like body holding part.

In this case, the string-like body held by the string-like body holding part is unlikely to enter into the string-like body guiding part, and the string-like body therefore is unlikely to come off from the string-like body guiding part. Here, when the string-like body has an elastic property, the thickness of the string-like body in the stretched state is thinner than the thickness of the string-like body in the unstretched state. Therefore, for example, by making the thickness of the string-like body in the stretched state thinner than the width of the string-like body guiding part and making the thickness of the string-like body in an unstretched state thicker than the width of the string-like body guiding part, it becomes possible to prevent the string-like body in the unstretched state from entering into the string-like body guiding part. Accordingly, the string-like body can be more assuredly made unlikely to come off particularly when the string-like body has an elastic property.

The article according to another embodiment may be a mask.

In this case, the string-like body can be moved smoothly in the penetration direction of the string-like body holding part in the state in which the string-like body is held by the string-like body holding part. Therefore, adjustment of the length of the string-like body can be easily performed, for example, in the state in which the wearer has put on the mask. Also, soreness of the wearer's face can be easily alleviated, and comfortable wearing of the mask can be easily realized. Furthermore, when movement of the string-like body in the front, back, left, and right directions can be restricted, adjustment (regulation) of the length of the string-like body can be performed exactly and an effect of not impairing the feel of fit of the mask is obtained.

Also, because the string-like body can be made unlikely to come off from the fastener, it is possible to prevent the string-like body from coming off when putting the mask on or taking the mask off, and it is furthermore possible to prevent the string-like body from coming off during adjustment of the length of the string-like body. Accordingly, because it is possible to prevent the mask from coming off from the wearer, it is possible to prevent the trouble of the wearer having to put the mask on again. Also, because attachment of the string-like body is facilitated, the string-like body can be easily fastened to the fastener by machine, and the number of masks produced per unit time can be increased. Accordingly, a contribution is made also to increasing productivity when producing masks.

The present invention was described in detail on the basis of embodiments thereof. However, the present invention is not limited to the above embodiments. Various modifications of the present invention are possible within a scope not deviating from the gist indicated by the claims.

1. A fastener for fastening a string-like body to an article, the fastener comprising:
a slit opening part for inserting the string-like body; and
a string-like body holding part which communicates with the slit opening part and holds the string-like body inserted from the slit opening part; wherein:
the string-like body holding part extends in the left and right directions from the slit opening part;
a surface of the string-like body holding part facing the slit opening part is smooth; and
a projecting part is provided at a position adjacent to the slit opening part on the surface of the string-like body holding part.

2. The fastener according to claim 1, wherein a protruding part is further provided at the surface of the string-like body holding part.

3. The fastener according to claim 2, wherein a height of the projecting part is higher than a height of the protruding part.

4. The fastener according claim 1, wherein:
the fastener has a fixing part to be fixed to the article; and
the fastener has a shape in which the slit opening part and the string-like body holding part are spaced apart from the article when the fastener is fixed to the article by the fixing part.

5. The fastener according to claim 1, wherein:
the slit opening part has a string-like body insertion part and a string-like body guiding part; and
a width of the string-like body guiding part is narrower than a width of the string-like body holding part.

6. An article equipped with the fastener according to claim 1.

7. The article according to claim 6, wherein the article is a mask.
